(19) United States
(12) Patent Application Publication
(10) Pub. No.: US 2026/0100062 A1
(43) Pub. Date: Apr. 9, 2026

(54) EXPLORE UNTIL CONFIDENT: EFFICIENT EXPLORATION FOR EMBODIED QUESTION ANSWERING

(71) Applicants: TOYOTA RESEARCH INSTITUTE, INC., Los Altos, CA (US); THE TRUSTEES OF PRINCETON UNIVERSITY, Princeton, NJ (US); THE BOARD OF TRUSTEES OF THE LELAND STANFORD JUNIOR UNIVERSITY, Stanford, CA (US)

(72) Inventors: Zhiyi REN, Princeton, NJ (US); Jaden V. CLARK, Claremont, CA (US); Anushri Chandrashekhar DIXIT, Los Angeles, CA (US); Mikhal ITKINA, Stanford, CA (US); Anirudha MAJUMDAR, Hillsborough, NJ (US); Dorsa SADIGH, Palo Alto, CA (US)

(73) Assignees: TOYOTA RESEARCH INSTITUTE, INC., Los Altos, CA (US); TOYOTA JIDOSHA KABUSHIKI KAISHA, Aichi-Ken (JP); THE TRUSTEES OF PRINCETON UNIVERSITY, Princeton, NJ (US); THE BOARD OF TRUSTEES OF THE LELAND STANFORD JUNIOR UNIVERSITY, Stanford, CA (US)

(21) Appl. No.: 18/906,060

(22) Filed: Oct. 3, 2024

Related U.S. Application Data
(60) Provisional application No. 63/627,957, filed on Feb. 1, 2024.

(51) Int. Cl. G06V 20/70; G06V 20/40

(52) U.S. Cl. CPC G06V 20/70; G06V 20/41

(57) ABSTRACT

A method for embodied agent exploration is described. The method includes building a semantic map of a surrounding scene based on depth information and via visual prompting of a vision language model (VLM). The method also includes utilizing conformal prediction to calibrate a question answering confidence of the VLM. The method further includes performing, by an embodied agent, scene exploration utilizing knowledge of relevant regions of the scene. The method also includes determining, by the embodied agent, when to terminate the scene exploration utilizing a calibrated question answering confidence of the VLM.

### CROSS-REFERENCE TO RELATED APPLICATION

The present application claims the benefit of U.S. Provisional Patent Application No. 63/627,957, filed Feb. 1, 2024, and titled “EXPLORE UNTIL CONFIDENT: EFFICIENT EXPLORATION FOR EMBODIED QUESTION ANSWERING,” the disclosure of which is expressly incorporated by reference herein in its entirety.

### GOVERNMENT SUPPORT CLAUSE STATEMENT

This invention was made with government support under Grant Nos. 2044149 and 1941722 awarded by the National Science Foundation, Grant Nos. N00014-23-1-2148 and N00014-22-1-2293 awarded by the Office of Naval Research, Grant Nos. W911NF-22-1-0214 and HR0011-24-9-0375 awarded by the Defense Advanced Research Projects Agency. The government has certain rights in the invention.

### BACKGROUND

### Field

Certain aspects of the present disclosure relate to machine learning and, more particularly, efficient exploration for embodied question answering in robotic devices.

### Background

Autonomous agents (e.g., robots, etc.) rely on machine vision for sensing a surrounding environment by analyzing areas of interest in images of the surrounding environment. Although scientists have spent decades studying the human visual system, a solution for realizing equivalent machine vision remains elusive. Realizing equivalent machine vision is a goal for enabling truly autonomous agents. Machine vision is distinct from the field of digital image processing because of the desire to recover a three-dimensional (3D) structure of the world from images and using the 3D structure for fully understanding a scene. That is, machine vision strives to provide a high-level understanding of a surrounding environment, as performed by the human visual system.

Vision language models (VLMs) are models that can learn simultaneously from images and texts to tackle many tasks, from visual question answering to image captioning. Nevertheless, there are two main challenges when using VLMs in embodied question answering (EQA): (1) VLMs do not include an internal memory for mapping a scene to plan how the scene is explored over time, and (2) confidence of VLMs can be miscalibrated, potentially causing a robot to prematurely stop exploration or over-explore. A method of efficient exploration for embodied question answering in robotic devices, is desired.

### SUMMARY

A method for embodied agent exploration is described. The method includes building a semantic map of a surrounding scene based on depth information and via visual prompting of a vision language model (VLM). The method also includes utilizing conformal prediction to calibrate a question answering confidence of the VLM. The method further includes performing, by an embodied agent, scene exploration utilizing knowledge of relevant regions of the scene. The method also includes determining, by the embodied agent, when to terminate the scene exploration utilizing a calibrated question answering confidence of the VLM.

A non-transitory computer-readable medium having program code recorded thereon for embodied agent exploration is described. The program code is executed by a processor. The non-transitory computer-readable medium includes program code to build a semantic map of a surrounding scene based on depth information and via visual prompting of a vision language model (VLM). The non-transitory computer-readable medium also includes program code to utilize conformal prediction to calibrate a question answering confidence of the VLM. The non-transitory computer-readable medium further includes program code to perform, by the embodied agent, scene exploration utilizing knowledge of relevant regions of the scene. The non-transitory computer-readable medium also includes program code to determine, by the embodied agent, when to terminate the scene exploration utilizing a calibrated question answering confidence of the VLM.

A system for embodied agent exploration is described. The system includes a semantic map module to build a semantic map of a surrounding scene based on depth information and via visual prompting of a vision language model (VLM). The system also includes a calibration module to utilize conformal prediction to calibrate a question answering confidence of the VLM. The system further includes a scene exploration module to perform, by the embodied agent, scene exploration utilizing knowledge of relevant regions of the scene. The system also includes an exploration termination module to determine, by the embodied agent, when to terminate the scene exploration utilizing a calibrated question answering confidence of the VLM.

This has outlined, broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a system using a system-on-a-chip (SOC) for efficient exploration of embodied question answering in robotic devices, in accordance with aspects of the present disclosure.

FIG. 2 is a block diagram illustrating a software architecture for efficient exploration of embodied question answering in robotic devices, according to aspects of the present disclosure.

FIG. 3 is a diagram illustrating an example of a hardware implementation for an embodied agent exploration system based on embodied question answering (EQA), according to various aspects of the present disclosure.

FIG. 4 provides an embodied agent exploration framework of a proposed embodied question answering (EQA)-based planning and control process, according to various aspects of the present disclosure.

FIG. 5 illustrates a proposed embodied question answering (EQA)-based planning and control process, according to various aspects of the present disclosure.

FIG. 6 illustrates a proposed embodied question answering (EQA)-based planning and control process, according to various aspects of the present disclosure.

FIG. 7 is a flowchart illustrating a method for embodied agent exploration, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. Any aspect of the present disclosure disclosed may be embodied by one or more elements of a claim.

Although aspects are described herein, many variations and permutations of these aspects fall within the scope of the present disclosure. Although some benefits and advantages of the preferred aspects are mentioned, the scope of the present disclosure is not intended to be limited to benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Autonomous agents (e.g., robots, etc.) rely on machine vision for sensing a surrounding environment by analyzing areas of interest in images of the surrounding environment. Although scientists have spent decades studying the human visual system, a solution for realizing equivalent machine vision remains elusive. Realizing equivalent machine vision is a goal for enabling truly autonomous agents. Machine vision is distinct from the field of digital image processing because of the desire to recover a three-dimensional (3D) structure of the world from images and using the 3D structure for fully understanding a scene. That is, machine vision strives to provide a high-level understanding of a surrounding environment, as performed by the human visual system. Humans can instantly imagine complete shapes of multiple novel objects in a cluttered scene via advanced geo-metric and semantic reasoning. This ability is also essential for robots if they are to effectively perform useful tasks in the real world.

Vision language models (VLMs) are models that can learn simultaneously from images and texts to tackle many tasks, from visual question answering to image captioning. Nevertheless, there are two main challenges when using VLMs in embodied question answering (EQA): (1) VLMs do not include an internal memory for mapping a scene to plan how the scene is explored over time, and (2) confidence of VLMs can be miscalibrated, potentially causing a robot to prematurely stop exploration or over-explore. A method of efficient exploration for embodied question answering in robotic devices, is desired.

Various aspects of the present disclosure are directed to an approach for embodied question answering (EQA). Various aspects of the present disclosure leverage the strong semantic reasoning capabilities of large vision language models (VLMs) to efficiently explore and answer such questions. Some aspects of the present disclosure are directed to a method that first builds a semantic map of a scene based on depth information and via visual prompting of a VLM-leveraging its vast knowledge of relevant regions of the scene for exploration. Next, conformal prediction is utilized to calibrate the VLM's question answering confidence, allowing the robot to know when to stop exploration. This use of conformal prediction leads to a more calibrated and efficient exploration strategy. In particular, various aspects of the present disclosure provide a framework that leverages a VLM for answering open-ended questions in diverse 3D scenes by: (1) fusing the commonsense/semantic reasoning abilities of a VLM into a global geometric map to enable efficient exploration; and (2) utilizing the theory of multi-step conformal prediction to formally quantify VLM uncertainty about the question.

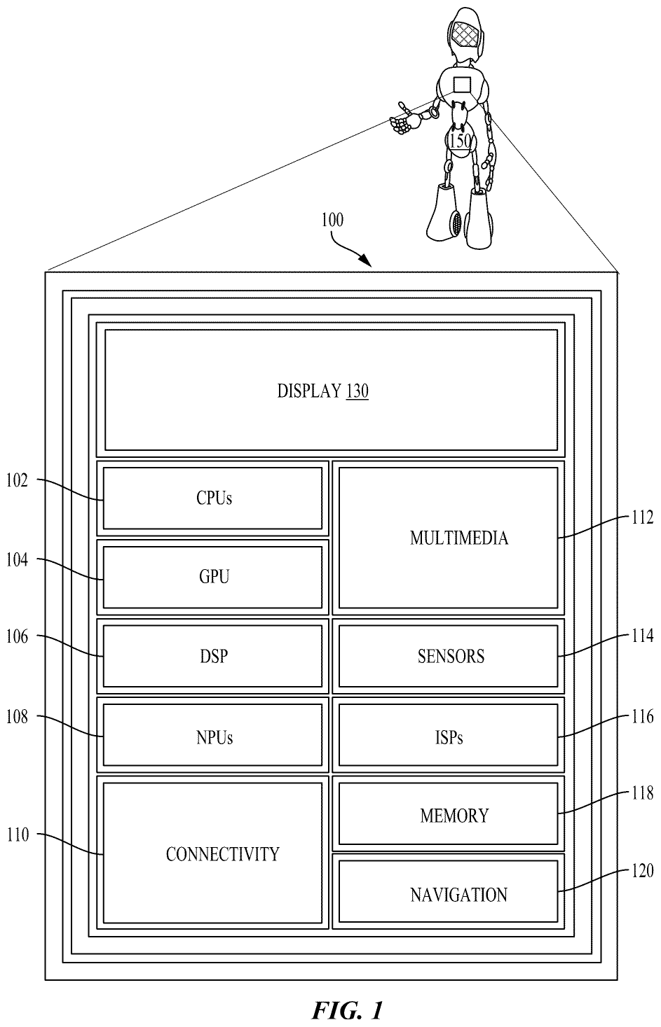

FIG. 1 illustrates an example implementation of a system and method for efficient exploration of embodied question answering in robotic devices using a system-on-a-chip (SOC) 100 of a robot 150. The SOC 100 may include a single processor or multi-core processors (e.g., a central processing unit), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include sixth generation (6G) connectivity, sixth generation (6G) new radio (NR) connectivity, fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, classify and categorize poses of objects in an area of interest, according to the display 130 illustrating a view of a robot. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system.

The SOC 100 may be based on an Advanced Risk Machine (ARM) instruction set or the like. In another aspect of the present disclosure, the SOC 100 may be a server computer in communication with the robot 150. In this arrangement, the robot 150 may include a processor and other features of the SOC 100. In this aspect of the present disclosure, instructions loaded into a processor (e.g., CPU 102) or the NPU 108 of the robot 150 may include code for planning and control (e.g., of the robot 150) to perform efficient exploration of embodied question answering from images captured by the sensor processor 114.

The instructions loaded into a processor (e.g., CPU 102) may also include code to build a semantic map of a surrounding scene based on depth information and via visual prompting of a vision language model (VLM). The instructions loaded into a processor (e.g., CPU 102) may further include code to utilize conformal prediction to calibrate a question answering confidence of the VLM. The instructions loaded into a processor (e.g., CPU 102) may also include code to perform, by a robot, scene exploration utilizing knowledge of relevant regions of the scene. The instructions loaded into a processor (e.g., CPU 102) may further include code to determine, by the robot, when to terminate the scene exploration utilizing a calibrated question answering confidence of the VLM.

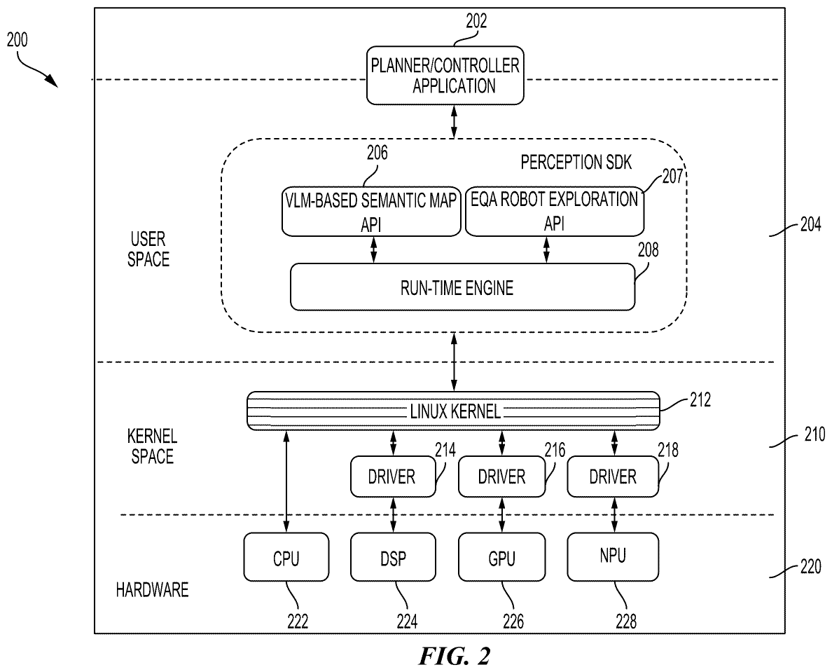

FIG. 2 is a block diagram illustrating a software architecture 200 for efficient exploration of embodied question answering in robotic devices, according to aspects of the present disclosure. Using the software architecture 200, a planner/controller application 202 may be designed such that it may cause various processing blocks of an SOC 220 (for example a CPU 222, a DSP 224, a GPU 226, and/or an NPU 228) to perform supporting computations during run-time operation of the planner/controller application 202.

The planner/controller application 202 may be configured to call functions defined in a user space 204 that may, for example, utilize embodied question answering (EQA). Various aspects of the present disclosure propose efficient robot exploration using EQA. In various aspects of the present disclosure, a robot determines when to terminate the scene exploration utilizing a calibrated question answering confidence of a vision language model (VLM).

In various aspects of the present disclosure, the planner/controller application 202 may make a request to compile program code associated with a library defined in a VLM-based semantic map application programming interface (API) 206 to build a semantic map of a surrounding scene based on depth information and via visual prompting of a VLM. The VLM-based semantic map API 206 may also utilize conformal prediction to calibrate a question answering confidence of the VLM. An EQA robot exploration API 207 may direct a robot to perform scene exploration utilizing knowledge of relevant regions of the scene. Additionally, the EQA robot exploration API 207 may enable the robot to determine when to terminate the scene exploration utilizing a calibrated question answering confidence of the VLM.

A run-time engine 208, which may be compiled code of a run-time framework, may be further accessible to the planner/controller application 202. The planner/controller application 202 may cause the run-time engine 208, for example, to perform embodied question answering from efficient exploration of an environment. When an object is associated with the embodied question answering is detected within a predetermined distance of the robot, the run-time engine 208 may in turn send a signal to an operating system 210, such as a Linux Kernel 212, running on the SOC 220. The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228 if present.

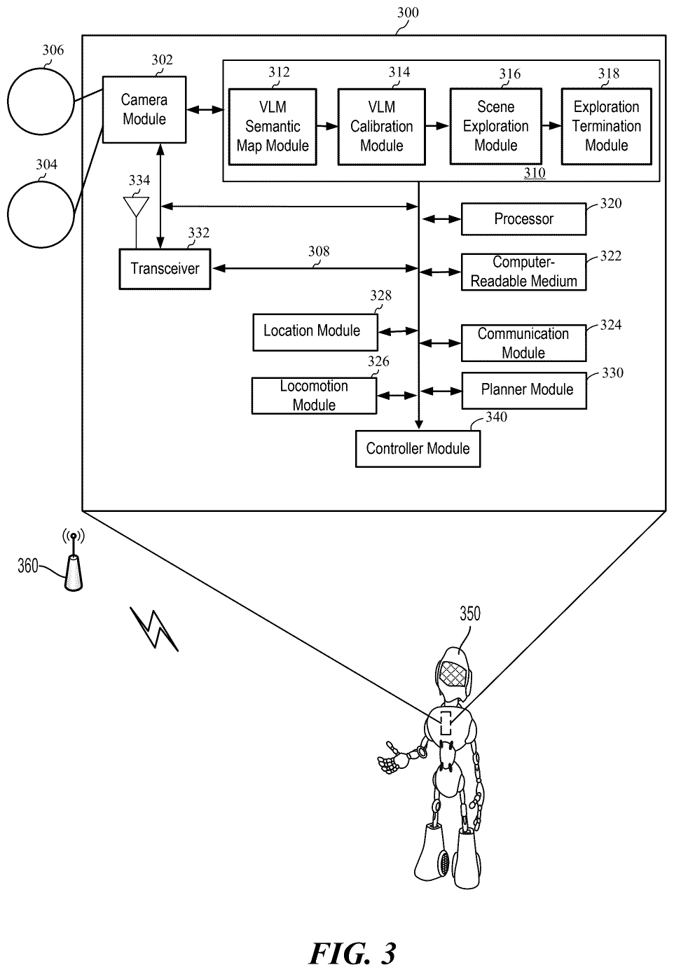

FIG. 3 is a diagram illustrating an example of a hardware implementation for an embodied agent exploration system 300 based on embodied question answering (EQA), according to various aspects of the present disclosure. The embodied agent exploration system 300 may be configured for EQA-based planning and control of a robot 350 in response to images from video captured through a camera during operation of the robot 350. The embodied agent exploration system 300 may be a component of a robotic or other autonomous device. For example, as shown in FIG. 3, the embodied agent exploration system 300 is a component of the robot 350. Aspects of the present disclosure are not limited to the embodied agent exploration system 300 being a component of the robot 350, as other devices, such as an autonomous vehicle, a bus, a motorcycle, or other like autonomous vehicles, are also contemplated for using the embodied agent exploration system 300. The robot 350 may be autonomous or semi-autonomous.

The embodied agent exploration system 300 may be implemented with an interconnected architecture, such as a controller area network (CAN) bus, represented by an interconnect 308. The interconnect 308 may include any number of point-to-point interconnects, buses, and/or bridges depending on the specific application of the embodied agent exploration system 300 and the overall design constraints of the robot 350. The interconnect 308 links together various circuits, including one or more processors and/or hardware modules, represented by a camera module 302, a perception module 310, a processor 320, a computer-readable medium 322, a communication module 324, a locomotion module 326, a location module 328, a planner module 330, and a controller module 340. The interconnect 308 may also link various other circuits such as timing sources, peripherals, voltage regulators, and power management circuits, which are well known in the art, and therefore, will not be described any further.

The embodied agent exploration system 300 includes a transceiver 332 coupled to the camera module 302, the perception module 310, the processor 320, the computer-readable medium 322, the communication module 324, the locomotion module 326, the location module 328, a planner module 330, and the controller module 340. The transceiver 332 is coupled to an antenna 334. The transceiver 332 communicates with various other devices over a transmission medium. For example, the transceiver 332 may receive commands via transmissions from a user or a remote device. As discussed herein, the user may be in a location that is remote from the location of the robot 350. As another example, the transceiver 332 may transmit EQA results from the perception module 310 to a server (not shown).

The embodied agent exploration system 300 includes the processor 320 coupled to the computer-readable medium 322. The processor 320 performs processing, including the execution of software stored on the computer-readable medium 322 to provide functionality, according to the present disclosure. The software, when executed by the processor 320, causes the embodied agent exploration system 300 to perform the various functions described for robotic perception and exploration of a surrounding environment from scenes in video captured by a camera of an autonomous agent, such as the robot 350, or any of the modules (e.g., 302, 310, 324, 326, 328, 330, and/or 340). The computer-readable medium 322 may also be used for storing data that is manipulated by the processor 320 when executing the software.

The camera module 302 may obtain images via different cameras, such as a first camera 304 and a second camera 306. The first camera 304 and the second camera 306 may be a vision sensor (e.g., a stereoscopic camera or a red-green-blue (RGB) camera) for capturing 2D RGB images. Alternatively, the camera module may be coupled to a ranging sensor, such as a light detection and ranging (LIDAR) sensor or a radio detection and ranging (RADAR) sensor. Of course, aspects of the present disclosure are not limited to the sensors, as other types of sensors (e.g., thermal, sonar, and/or lasers) are also contemplated for either of the first camera 304 or the second camera 306.

The images of the first camera 304 and/or the second camera 306 may be processed by the processor 320, the camera module 302, the perception module 310, the communication module 324, the locomotion module 326, the location module 328, and the controller module 340. In conjunction with the computer-readable medium 322, the images from the first camera 304 and/or the second camera 306 are processed to implement the functionality described herein. In one configuration, detected 2D object information captured by the first camera 304 and/or the second camera 306 may be transmitted via the transceiver 332. The first camera 304 and the second camera 306 may be coupled to the robot 350 or may be in communication with the robot 350.

The location module 328 may determine a location of the robot 350 using simultaneous localization and mapping (SLAM). Alternatively, the location module 328 may use a global positioning system (GPS) to determine the location of the robot 350. The location module 328 may implement a dedicated short-range communication (DSRC)-compliant GPS unit. A DSRC-compliant GPS unit includes hardware and software to make the robot 350 and/or the location module 328 compliant with one or more of the following DSRC standards, including any derivative or fork thereof: EN 12253:2004 Dedicated Short-Range Communication-Physical layer using microwave at 5.9 GHZ (review); EN 12795:2002 Dedicated Short-Range Communication (DSRC)-DSRC Data link layer: Medium Access and Logical Link Control (review); EN 12834:2002 Dedicated Short-Range Communication-Application layer (review); EN 13372:2004 Dedicated Short-Range Communication (DSRC)-DSRC profiles for RTTT applications (review); and EN ISO 14906:2004 Electronic Fee Collection-Application interface.

A DSRC-compliant GPS unit within the location module 328 is operable to provide GPS data describing the location of the robot 350 with space-level accuracy for accurately directing the robot 350 to a desired location. For example, the robot 350 is moving to a predetermined location and desires partial sensor data. Space-level accuracy means the location of the robot 350 is described by the GPS data sufficient to confirm a location of the robot 350 parking space. That is, the location of the robot 350 is accurately determined with space-level accuracy based on the GPS data from the robot 350.

The communication module 324 may facilitate communications via the transceiver 332. For example, the communication module 324 may be configured to provide communication capabilities via different wireless protocols, such as Wi-Fi, long term evolution (LTE), 3G, etc. The communication module 324 may also communicate with other components of the robot 350 that are not modules of the embodied agent exploration system 300. The transceiver 332 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

In some configurations, the network access point 360 includes Bluetooth® communication networks or a cellular communications network for sending and receiving data, including via short messaging service (SMS), multimedia messaging service (MMS), hypertext transfer protocol (HTTP), direct data connection, wireless application protocol (WAP), e-mail, DSRC, full-duplex wireless communications, mmWave, Wi-Fi (infrastructure mode), Wi-Fi (ad-hoc mode), visible light communication, TV white space communication, and satellite communication. The network access point 360 may also include a mobile data network that may include 3G, 4G, 5G, 6G, LTE, LTE-V2X, LTE-D2D, VoLTE, or any other mobile data network or combination of mobile data networks. Further, the network access point 360 may include one or more IEEE 802.11 wireless networks.

The embodied agent exploration system 300 also includes the planner module 330 for planning a selected trajectory to perform a route/action (e.g., collision avoidance) of the robot 350 and the controller module 340 to control the locomotion of the robot 350. The controller module 340 may perform the selected action via the locomotion module 326 for autonomous operation of the robot 350 along, for example, a selected route. In one configuration, the planner module 330 and the controller module 340 may collectively override a user input when the user input is expected (e.g., predicted) to cause a collision according to an autonomous level of the robot 350. The modules may be software modules running in the processor 320, resident/stored in the computer-readable medium 322, and/or hardware modules coupled to the processor 320, or some combination thereof.

The National Highway Traffic Safety Administration (NHTSA) has defined different “levels” of autonomous agents (e.g., Level 0, Level 1, Level 2, Level 3, Level 4, and Level 5). For example, if an autonomous agent has a higher-level number than another autonomous agent (e.g., Level 3 is a higher-level number than Levels 2 or 1), then the autonomous agent with a higher-level number offers a greater combination and quantity of autonomous features relative to the agent with the lower-level number. These distinct levels of autonomous agents are described briefly below.

Level 0: In a Level 0 agent, the set of advanced driver assistance system (ADAS) features installed in an agent provide no agent control but may issue warnings to the driver of the agent. An agent which is Level 0 is not an autonomous or semi-autonomous agent.

Level 1: In a Level 1 agent, the driver is ready to take operation control of the autonomous agent at any time. The set of ADAS features installed in the autonomous agent may provide autonomous features such as: adaptive cruise control (ACC); parking assistance with automated steering; and lane keeping assistance (LKA) type II, in any combination.

Level 2: In a Level 2 agent, the driver is obliged to detect objects and events in the roadway environment and respond if the set of ADAS features installed in the autonomous agent fail to respond properly (based on the driver's subjective judgement). The set of ADAS features installed in the autonomous agent may include accelerating, braking, and steering. In a Level 2 agent, the set of ADAS features installed in the autonomous agent can deactivate immediately upon takeover by the driver.

Level 3: In a Level 3 ADAS agent, within known, limited environments (such as freeways), the driver can safely turn their attention away from operation tasks but must still be prepared to take control of the autonomous agent when needed.

Level 4: In a Level 4 agent, the set of ADAS features installed in the autonomous agent can control the autonomous agent in all but a few environments, such as severe weather. The driver of the Level 4 agent enables the automated system (which is comprised of the set of ADAS features installed in the agent) only when it is safe to do so. When the automated Level 4 agent is enabled, driver attention is not required for the autonomous agent to operate safely and consistent within accepted norms.

Level 5: In a Level 5 agent, other than setting the destination and starting the system, no human intervention is involved. The automated system can drive to any location where it is legal to drive and make its own decision (which may vary based on the district where the agent is located).

A highly autonomous agent (HAA) is an autonomous agent that is Level 3 or higher. Accordingly, in some configurations the robot 350 is one of the following: a Level 0 non-autonomous agent; a Level 1 autonomous agent; a Level 2 autonomous agent; a Level 3 autonomous agent; a Level 4 autonomous agent; a Level 5 autonomous agent; and an HAA.

The perception module 310 may be in communication with the camera module 302, the processor 320, the computer-readable medium 322, the communication module 324, the locomotion module 326, the location module 328, the planner module 330, the transceiver 332, and the controller module 340. In one configuration, the perception module 310 receives sensor data from the camera module 302. The camera module 302 may receive RGB video image data from the first camera 304 and the second camera 306. According to aspects of the present disclosure, the perception module 310 may receive RGB video image data directly from the first camera 304 or the second camera 306 as well as an RGB depth (RGB-D) to explore an enviroment from images captured by the first camera 304 and the second camera 306 of the robot 350. In various aspects of the present disclosure, the planner module 330 and/or the controller module 340 is configured for planning and control of the robot 350 to explore an environment and perform embodied question answering, as follows.

Vision language models (VLMs) are models that can learn simultaneously from images and texts to tackle many tasks, from visual question answering to image captioning. Nevertheless, there are two main challenges when using VLMs in embodied question answering (EQA): (1) VLMs do not include an internal memory for mapping a scene to plan how the scene is explored over time, and (2) confidence of VLMs can be miscalibrated, potentially causing a robot to prematurely stop exploration or over-explore. Various aspects of the present disclosure provide a framework that leverages a VLM for answering open-ended questions in diverse 3D scenes by: (1) fusing the commonsense/semantic reasoning abilities of a VLM into a global geometric map to enable efficient exploration; and (2) utilizing the theory of multi-step conformal prediction to formally quantify VLM uncertainty about the question.

As shown in FIG. 3, the perception module 310 includes a VLM semantic map module 312, a VLM calibration module 314, a scene exploration module 316, and an exploration termination module 318. The VLM semantic map module 312, the VLM calibration module 314, the scene exploration module 316, and the exploration termination module 318 may be components of a same or different artificial neural network, such as a convolutional neural network (CNN). The modules (e.g., 312, 314, 316, 318) of the perception module 310 are not limited to a CNN. In operation, the perception module 310 receives a video stream from the first camera 304 and the second camera 306. The video stream may include a 2D RGB left image from the first camera 304 and a 2D RGB right image from the second camera 306 to provide video frame images. The video stream may include multiple frames, such as image frames.

In some aspects of the present disclosure, the perception module 310 is configured for the embodied agent exploration system 300 based on embodied question answering (EQA). The perception module 310 includes the VLM semantic map module 312 to build a semantic map of a surrounding scene based on depth information and via visual prompting of a VLM. For example, building the semantic map includes fusing common sense/semantic reasoning abilities of the VLM into a global geometric semantic map to enable efficient exploration. Additionally, the perception module 310 includes the VLM calibration module 314 to utilize conformal prediction to calibrate a question answering confidence of the VLM. In various aspects of the present disclosure, the perception module 310 includes the scene exploration module 316 to perform, by the robot 350, scene exploration utilizing knowledge of relevant regions of the scene.

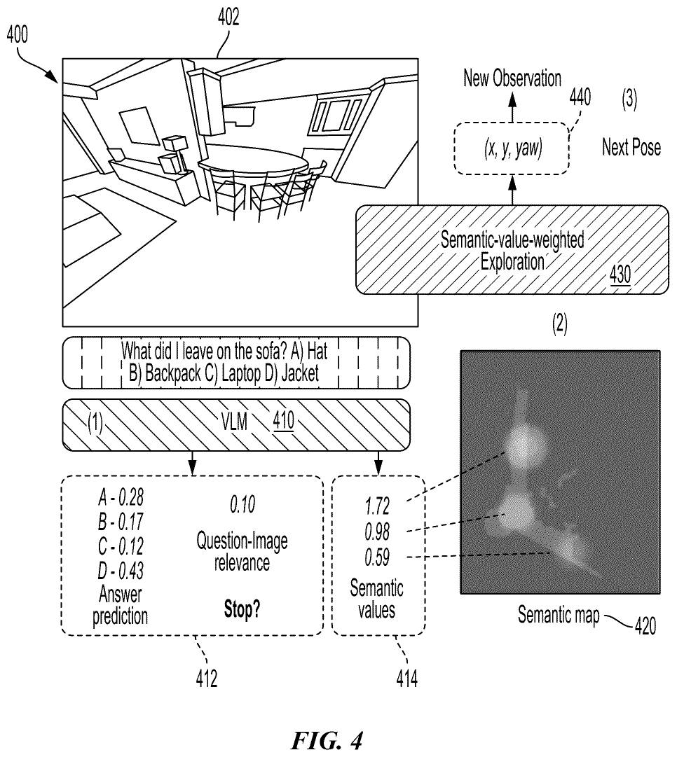

Additionally, the perception module 310 includes the exploration termination module 318 to determine, by the robot, when to terminate the scene exploration utilizing a calibrated question answering confidence of the VLM. The embodied agent exploration system 300 configured for EQA-based planning and control of the robot 350 in response to images from video captured through a camera during operation of the robot 350 is further illustrated, for example, as shown in FIG. 4.

Imagine that a service robot (e.g., an embodied agent) is sent to a home to perform various tasks, and the household owner asks the service robot to verify the stove is turned off. This setting is referred to as embodied question answering (EQA), in which a service robot starts at a random location in a 3D scene, explores the space, and stops when it is confident about answering the question. This can be a challenging problem due to highly diverse scenes and lack of an a-priori map of the environment. Conventional solutions rely on training dedicated exploration policies and question answering modules from scratch. Additionally, the models studied in prior work consider synthetic scenes and can be data-inefficient since the training is done from scratch.

Recently, large vision language models (VLMs) have achieved impressive performance in answering complex questions about static 2D images that sometimes involve reasoning. VLMs can also help the robot actively perceive a 3D scene given partial 2D views and reason about future actions for the robot to perform. Such capabilities are critical to performing EQA, as the robot can now better reason about relevant regions of the environment, actively explore them, and answer questions that require semantic reasoning (e.g., answering “what time is it now?” by searching for a clock). Unfortunately, there are two main challenges that arise in using VLMs for EQA in complex, diverse 3D scenes while trying to explore efficiently: (1) Limited Internal Memory of VLMs; and (2) miscalibrated VLMs.

Efficient exploration benefits from the robot tracking previously explored regions and ones yet to be explored but relevant for answering the question. Unfortunately, VLMs do not have an internal memory for mapping the scene and storing such semantic information. Additionally, VLMs are fine-tuned on pre-trained large language models (LLMs) as the language decoder, and LLMs are often miscalibrated—that is they can be over-confident or under-confident about the output. This makes it difficult to determine when the robot is confident enough about question answering in EQA and then stop exploration, affecting overall efficiency.

Various aspects of the present disclosure endow VLMs (having limited memory and the potential for miscalibration) with the capability of efficient exploration for EQA. To address the first challenge, various aspects of the present disclosure construct a semantic map external to the VLM, combining the VLM's visual reasoning within the local view with the global geometric information of the map, and thus informing planning for the next waypoint. To address the second challenge, aspects of the present disclosure apply rigorous uncertainty quantification on the VLM's EQA predictions, such that the robot knows when it should stop to satisfy a certain level of prediction success. For example, building a semantic map may include prompting the embodied agent using first potential points in a current view of the surrounding scene to obtain a locally semantic value (LSV). This is followed by prompting the embodied agent using second potential points in an entire view of the surrounding scene to obtain a globally semantic value (GSV).

FIG. 4 provides an embodied agent exploration framework 400 of a proposed embodied question answering (EQA)-based planning and control process, according to various aspects of the present disclosure. The embodied agent exploration framework 400 leverages a vision language model (VLM) 410 for answering open-ended questions in a diverse 3D scene 402. According to various aspects of the present disclosure, the embodied agent exploration framework 400 operates by (1) fusing the commonsense/semantic reasoning abilities of the VLM 410 into a global geometric map (e.g., semantic map 420) to enable efficient exploration (e.g., semantic-value-weighted exploration 430). Additionally, the embodied agent exploration framework 400 (2) uses the theory of multi-step conformal prediction to formally quantify VLM uncertainty about the question (e.g., What did I leave on the sofa? A) Hat B) Backpack C) Laptop D) Jacket).

According to various aspects of the present disclosure, a robot builds the semantic map 420 of the scene 402, in which the semantic map 420 stores information on occupancy and locations the VLM 410 deems worthy of exploring. For example, semantic information (e.g., semantic values 414) is obtained by annotating the free space in the current image view of the scene 402, prompting the VLM 410 to choose among the unoccupied regions, and querying its predictions 412. In various aspects of the present disclosure, heuristic planning is then applied to prioritize the robot exploring semantically relevant regions. For example, throughout an episode, the robot maintains a set of answers as part of the predictions 412, updates the set at each step based on new visual information provided to the VLM 410, and stops exploration when the set of answers reduces to a single option. Conformal prediction formally ensures the set covers the true answer with high probability and, hence, the robot can terminate exploration with calibrated confidence. Conformal prediction also minimizes the set size and, thus, the robot can stop as soon as possible to avoid over-exploration.

As shown in FIG. 4, the embodied agent exploration framework 400 for EQA tasks combines the VLM 410 and the external, semantic map 420 for planning. Given the question about the scene (“What did I leave on the sofa? A) Hat B) Backpack C) Laptop D) Jacket”), the embodied agent exploration framework 400 leverages the VLM 410 to obtain semantic information (e.g., predictions 412 and semantic values 414) from the views of the scene 402 (visualized by overlaying the views on top of an occupancy map). In this example, the semantic-value-weighted exploration 430 guides a fetch robot to explore relevant locations 440 (e.g., x, y, yaw of a next pose) for new observations. Using the semantic map 420 helps the robot explore more efficiently compared to conventional robotic exploration, which is performed without using any semantic information.

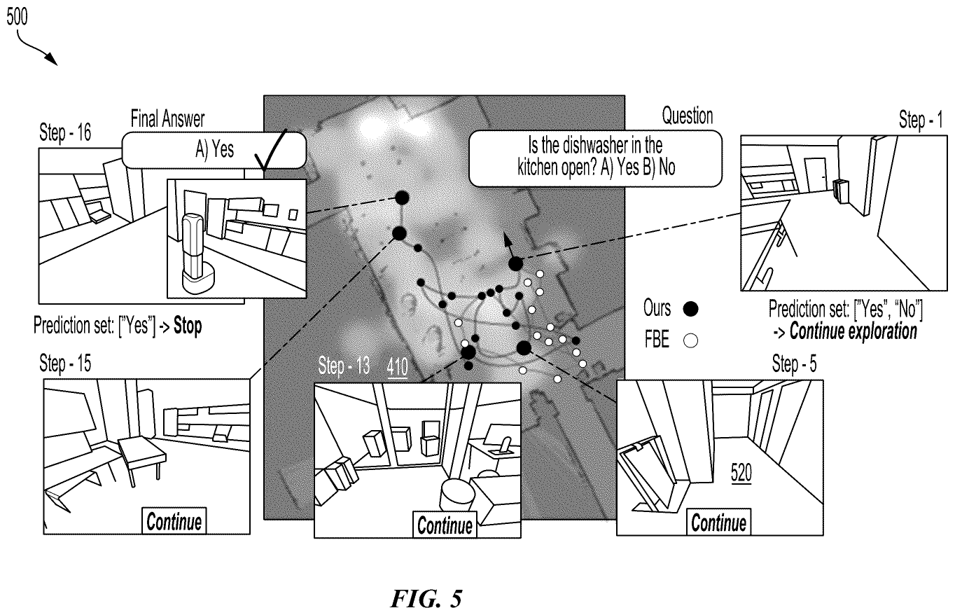

FIG. 5 illustrates a proposed embodied question answering (EQA)-based planning and control process 500, according to various aspects of the present disclosure. Given a question about the scene (“Is the dishwasher in the kitchen open? A) Yes B) No”), the EQA-based planning and control process 500 leverages a large vision language model (VLM) to obtain semantic information from the views (visualized by overlaying on top of an occupancy map), which guides a fetch robot to explore relevant locations. Using a semantic map 520 helps the robot explore more efficiently compared to frontier-based exploration without using any semantic values. The robot maintains a set of answers and stops when the set reduces to a single answer based on the current view. In this example, the robot is confident at Step 16 where it sees the open dishwasher not too far from its position. The robot paths (thin lines) are approximated.

For simulated experiments, a new EQA dataset is described based on realistic human-robot scenarios and the habitat-matterport 3D research dataset (HM3D), which provides photo-realistic, diverse indoor 3D scans. Additionally, hardware experiments are performed in home/office-like environments using a fetch mobile robot. Both simulated and hardware experiments show that the EQA-based planning and control process 500 improves the EQA efficiency over baselines that do not use semantic information from VLM reasoning and do not calibrate the VLM for stopping criteria.

### I. Problem Formulation

Distribution of scenarios for EQA. Embodied question answering (EQA) is formalized by considering an unknown joint distribution over scenarios ξ˜ [symbol] the robot can encounter. A scenario is a tuple ξ:=(e, T, g⁰, q, y), where e is a simulated or real 3D scene (e.g., a floor plan with certain dimensions), T is the maximum number of time steps allowed for the robot to navigate in the scene (e.g., a function of scene size), g⁰ is the robot's initial pose (2D position and orientation at time 0), q is the questions, and y is the ground truth answer. A subscript is used to indicate the scenario (e.g., T_{ξ} for the maximum time horizon in scenario ξ), and a superscript t for time steps (e.g., g^{t} for the robot's pose at time t). In various aspects of the present disclosure, multiple-choice questions q is considered e.g., “Where did I leave the black suitcase? A) Bedroom B) Living room C) Storage room D) Dining room.” Additionally, four choices are assumed for each question, and thus the set of labels y: ={‘A,’ ‘B,’ ‘C,’ ‘D’} contains any answer y. In this example, no knowledge of [symbol] is assumed, except that a finite-size data is sampled of independent and identically distributed scenarios from [symbol] .

Robot navigating in a scenario. In this work, a robot is desired to perform EQA in any given scenario ξ∈ [symbol] . The robot is not expected to have any prior knowledge of the scene. The robot is initializing at g⁰, and t any time t it can traverse to different poses g^{t}. The robot's onboard camera provides RGB images

$${l}_{c}^{t}$$

∈ [symbol] ^{H}^{₁}^{×W}^{₁}^{×3} and depth images

$${l}_{f}^{t}$$

∈ [symbol] ^{H}^{₁}^{×W}^{₁}. A time step is associated with each time the robot stops and takes RGB/depth images. Later discussion below describes how to select when and where the robot should take images—for querying a VLM-via an active exploration strategy. Additionally, these examples assume access to a collision-free planner π that determines the next pose g^{t+1} to travel to, a maximum of 3 m away from g^{t}. Additionally, perfect odometry is assumed in simulation. In real-world settings, the robot can determine its new pose using a localization algorithm.

VLM predictions. A VLM pre-trained with large scale data provides information needed for solving the EQA task. The RGB image and a text prompt s are passed to the model and query its probability over predicting the next token. For convenience,

$${x}^{t} = ( {I}_{c}^{t} , q )$$

as denoted as consisting of the RGB image

$${I}_{c}^{t}$$

and the question q. Then, the VLM's prediction given the question q at time t can be denoted as \hat{f}(x^{t})∈[0,1]^{|y|}, which are the softmax scores over the multiple choice set y. \hat{f}_{y}(·) is denoted as the SoftMax score for a particular label y.

Goal: efficient exploration. In a new scenario, the robot may stop at any time step t≤T_{ξ}, and make a definitive answer to the question based on all the information (e.g., VLM predictions over time steps). One goal is to answer the question correctly in unseen test scenarios ξ∈ [symbol] , using a minimal number of time steps. This requires the robot to search for relevant information efficiently without over-exploration.

### II. Targeted Exploration Using VLM Reasoning

To improve exploration efficiency, various aspects of the present disclosure direct the robot to prioritize exploring regions relevant to answering the posed question. These aspects of the present disclosure utilize the rich knowledge from VLMs to guide exploration. However, as discussed earlier, VLMs have limited internal memory-they are unable to keep track of past and future relevant scenes. Various aspects of the present disclosure, instead, propose a novel solution for building a map of the scene external to the VLM, and embedding the VLM's knowledge about exploration directions into this map to guide the robot's exploration, as illustrated in FIG. 4.

### A. Overview

FIG. 4 provides an overview of the embodied agent exploration framework 400 of a proposed EQA-based planning and control process, according to various aspects of the present disclosure. For example, given the observation of the scene 402 and the question, a first prompt of the VLM 410 generates three different outputs: answer prediction probabilities over the four possible answers, the question-image relevance score relating how relevant the current view is for answering the question (e.g., predictions 412), and a set of semantic values 414 indicating if any regions in the view are worth exploring for answering the question. These values are then stored in the semantic map 420 external to the VLM 410, which also tracks free space and unknown regions. Various aspects of the present disclosure apply the semantic-value-weighted exploration 430 based on the semantic map 420 that guides the robot in exploring meaningful regions. The robot does not stop until it is confident about answering the question based on the answer prediction and question-image relevance of the predictions 412. For example, determining of relevant locations by the robot is performed by identifying free space in a current RGB image by (a) projecting onto a 2D point map M, (b) keeping free points, and (c) sampling a set of points P using farthest point sampling to ensure coverage.

### B. Exploration Map and Frontier-Based Exploration

For tracking where the robot has explored, various aspects of the present disclosure adopt a 3D voxel-based representation for the map of size L×W×H−W and L expand as the robot explores more areas, and H is fixed as 3.5 m (typical floor height). Each voxel corresponds to a cube with side length l. At each pose g^{t} with depth image

$${I}_{d}^{t}$$

∈ [symbol] ^{H}^{₁}^{×W}^{₁} and known camera intrinsics, volumetric truncated signed distance function (TSDF) fusion is applied to update (1) occupancy of the voxels and (2) if they are explored/seen in the current

$${I}_{d}^{t} .$$

While all voxels seen in

$${I}_{d}^{t}$$

are used to update occupancy, only those within a smaller field of view are used to update whether they have been explored, enabling more fine-grained exploration. At each time step, the 3D voxel map is projected into a 2D point map M: a 2D point is considered free (unoccupied) if all voxels up until 1.5 m are marked free, which is the height of the camera (in simulation and in reality) and considered explored if all voxels along H have been marked explored.

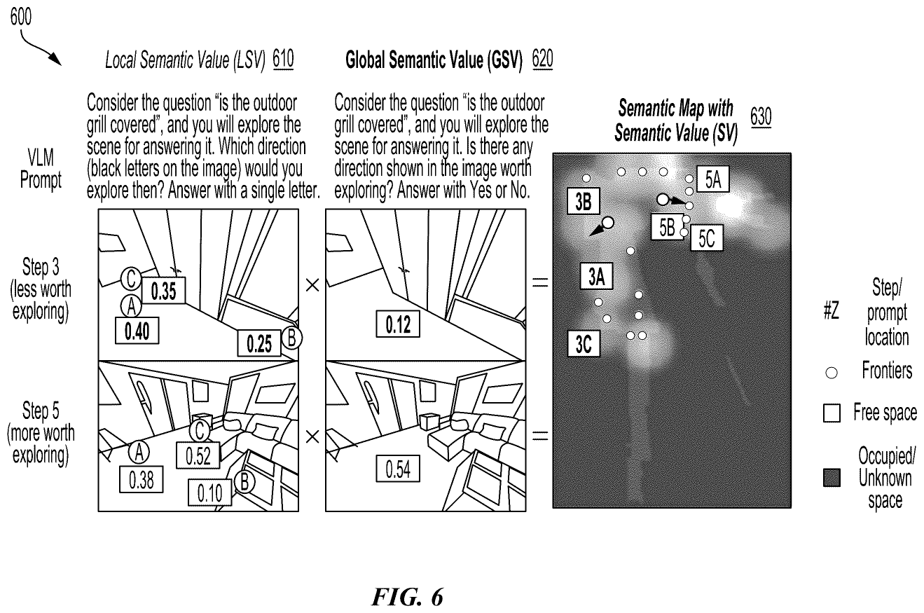

Based on the 2D map storing occupancy and exploration information, a heuristics-based 2D planner is used to plan new poses (e.g., x, y, yaw) around unexplored regions for new observations. Various aspects of the present disclosure expand on frontier-based exploration (FBE) for navigation tasks. FBE finds the frontiers, the locations at the boundary of the explored and unexplored regions, samples one as the planned location, and uses the normal direction to the unexplored region boundary as the planned orientation, for example, as shown in FIG. 6.

### C. VLM Visual Prompting for Semantic Value

FIG. 6 illustrates a proposed embodied question answering (EQA)-based planning and control process 600, according to various aspects of the present disclosure. Various aspects of the present disclosure rely on vision language model (VLM) access to rich prior knowledge from large-scale Internet data to potentially provide useful information in determining relevant locations to explore. For example, determining relevant locations to explore is achieved by obtaining the VLM's uncertainty over the possible locations via visual prompting. Given the current RGB image

$${I}_{c}^{t} ,$$

first identification of the free space seen in

$${I}_{c}^{t}$$

is performed by (a) projecting it onto M, (b) keeping only the free points, and (c) sampling a set of points P using farthest point sampling to ensure coverage. In practice, using |P|=3 is sufficient to cover the possible distinct regions in an image. Then, the sampled points are de-projected back onto

$${I}_{c}^{t}$$

and annotated with letters y_{P}={‘A’, ‘B’, ‘C’} on

$${I}_{c}^{t}$$

to get an annotated image

$${I}_{c}^{t} ,$$

y_{P}, which can be used for visual prompting. Now, the following prompt is provided:
Consider the question: {question}, and you will explore the scene for answering it. Which direction (black letters on the image) would you explore then? Answer with a single letter.

This example then used the (normalized) probability output of the VLM over each of the three directions to construct a local semantic value (LSV) 610 of p∈P.

$${LSV}_{p} ( {x}^{t} ) = {\hat{f}}_{y p} ( {x}^{t} ) = {\hat{f}}_{{y}_{p}} ( {I}_{c}^{t} , {s}_{LSV , q} ) ∈ [ 0 , 1 ] . \qquad ( 1 )$$

where

$${x}^{t} = ( {I}_{c}^{t} , q )$$

is the RGB image and quesstion and s_{LSV,q} is the prompt above with the question filled in. Note that this is a “local” score because the comparison is from one image, and the locations P are not suited for being compared to those seen in images taken from different poses g^{t} (e.g., see top and bottom rows in FIG. 6) when planning the next robot pose using M. To address this issue, various aspects of the present disclosure determine whether navigation to poses are visible from the current pose. Similarly, the VLM's uncertainty via visual prompting is obtained:
Consider the question: {question}, and you will explore the scene for answering it. Is there any direction shown in the image worth exploring? Answer with Yes or No.

This provides the global semantic value (GSV) (semantic map 520 shown in FIG. 5) of a given point p E P by querying the (normalized) probability of the VLM predicting ‘Yes’:

$${GSV}_{p} ( {x}^{t} ) = {\hat{f}}_{′ Yes ′} ( {x}^{t} ) = {\hat{f}}_{′ Ye s′} ( {I}_{c}^{t} , {s}_{GSV , q} ) ) ∈ [ 0 , 1 ] , \qquad ( 2 )$$

where again s_{GSV,q} is the prompt above with the question filled in. To determine the overall semantic value (SV), temperature scaling (τ_{LSV} and τ_{GSV}) is applied to each of the two values and compute the following score:

$$S {V}_{p} ( {x}^{t} ) = exp ( {τ}_{L S V} \cdot {LSV}_{p} ( {x}^{t} ) + {τ}_{G S V} \cdot {GSV}_{p} ( {x}^{t} ) ) . \qquad ( 3 )$$

In practice, Gaussian smoothing is applied, such that each value creates a Gaussian distribution around the point to better support the exploration strategy, which is explained below.

### D. Semantic-Value-Weighted Frontier Exploration

Now, details are provided for incorporating preferences in exploring high semantic-value regions using a semantic map 630—in which semantic value (SV) is applied as the weights when sampling the next frontier in which to navigate. Each weight is based on two values, SVₚ, the semantic value at point p, and SVₚ, Normal, defined as the average semantic value of the points within a certain distance d_{SV} from p in the normal direction. SV_{p,Normal} can be particularly useful to better guide the robot towards the relevant regions if they are not close to the robot's current pose. Gaussian smoothing around prompted points P improves this process.

For example, as further illustrated in FIG. 6, to query the VLM's uncertainty over exploration locations, the VLM is visually prompted with points in the current view (left column) and with the entire view (middle column) to obtain the LSV 610 and a Global Semantic Value (GSV) 620. A weighted combination of the semantic values (SV) is saved in the semantic map 630. The values are used as the weights for sampling the next frontier in which to navigate, guiding the robot towards unknown and relevant regions.

### III. Stopping Criterion for Exploration and Answering the Question

The various aspects of the present disclosure use vision language models (VLMs) to guide the exploration for answering embodied question answering (EQA). This closing section discusses how to address the first challenge of limited internal memory of VLMs by building a semantic value weighted map and using it for efficient exploration. Nevertheless, the second piece of efficient exploration is to know when you have enough information to answer the question and realize when you should stop exploring. This leads to the second challenge of miscalibrated VLMs, i.e., the fact that VLMs can be overconfident or under-confident about their answers.

Techniques for assessing VLM confidence in question answering typically rely on SoftMax scores. For example, one can compute the entropy of the predicted answer at each time step:

$$H ( \hat{f} ( {x}^{t} ) ) = - {\sum }_{y ∈ y} {\hat{f}}_{y} ( {x}^{t} ) log {\hat{f}}_{y} ( {x}^{t} ) , \qquad ( 4 )$$

and stop if this quantity is below a pre-defined threshold. Other techniques for assessing VLM confidence involve direct prompting. There is a subtle difference between this prompt and s_{GSV,q}. This one is about answering the question with the view, and s_{GSV,q} is for exploring directions within the view:
Consider the question: {question}. Are you confident about answering the question given the current view?

The probability of the model predicting ‘Yes’ with this prompt is then analyzed by referring to the question-image relevance score:

$$Rel ( {x}^{t} ) = {\hat{f}}_{′ Yes ′} ( {I}_{c}^{t} , ( q , {s}_{Rel , q} ) ) , \qquad ( 5 )$$

where s_{Rel,q} is the prompt above with the question filled in. By normalizing this quantity with the sum of confidences of predicting ‘Yes’ and ‘No,’ one obtains a scalar quantify bounded in [0,1]. A scalar threshold hᵣₑₗ E [0,1] can then be used as the stopping criterion.

While these stopping criteria are simple to implement, relying on the raw SoftMax scores from the VLM faces a major challenge. The SoftMax scores from VLMs are often miscalibrated, i.e., they are often over- or under-confident; this miscalibration is inherited from the underlying LLMs that are used to fine-tune VLMs. Through experimentation, the two options found above recognize that raw VLM SoftMax scores lead to the robot under-exploring or over-exploring in many scenarios (e.g., a miscalibrated Rel(x^{t})).

These observations motivate rigorous quantification of the VLM's uncertainty and careful calibration of the raw confidences. Various aspects of the present disclosure employ multi-step conformal prediction, which allows the robot to maintain a set of answers (prediction set) over time and stop when the set reduces to a single answer. Conformal prediction (CP) uses a moderately sized (e.g., ˜300) set of scenarios for carefully selecting a confidence threshold above which answers are included in the prediction set. This procedure achieves calibrated confidence: with a user-specified probability, the prediction set is guaranteed to contain the correct answer for a new scenario (under the assumption that calibration and test scenarios are drawn from the same unknown distribution D). CP also minimizes the prediction set size, which helps the robot to stop as quickly as it can while satisfying calibrated confidence.

### A. Background: Conformal Prediction

A brief overview of conformal prediction (CP) is provided in this section by first describing a single-step setting where a vision language model (VLM) must answer a question pertaining to a single image; then describe CP in the proposed multi-time-step active exploration setting, as described above.

Let [symbol] and [symbol] denote the space of inputs (images and corresponding questions) and labels (answers) respectively and let [symbol] denote an unknown distribution over [symbol] := [symbol] × [symbol] . Suppose a calibration dataset

$$𝒵 = {\{ {z}_{i} = ( {x}_{i} , {y}_{i} ) \}}_{i = 1}^{N}$$

of such pairs drawn i.i.d. is collected from [symbol] . Now, given a new i.i.d. sample zₜₑₛₜ=(xₜₑₛₜ, yₜₑₛₜ) with unknown true label yₜₑₛₜ, CP generates a prediction set C(xₜₑₛₜ)⊆ [symbol] that contains yₜₑₛₜ with high probability:

$$ℙ ( {y}_{test} ∈ C ( {x}_{test} ) ) \geq 1 - ϵ . \qquad ( 6 )$$

Here, 1−ϵ is a user-defined threshold that impacts the size of C(·).

CP provides this statistical guarantee on coverage by utilizing the dataset Z to perform a calibration procedure with raw (heuristic) confidence scores. This example setting defines the relevance-weighted confidence score for an input x as:

$${ρ}_{y} ( x ) := Rel ( x ) ( {\hat{f}}_{y} ( x ) - 1 ) . \qquad ( 7 )$$

This quantity is large when it is both the case that the VLM is confident in the answer y and the image is deemed highly relevant. CP utilizes these scores to evaluate the set of nonconformity scores

$${\{ {κ}_{i} = 1 - {p}_{{y}_{i}} ( {x}_{i} ) \}}_{i = 1}^{N}$$

over the calibration set. Intuitively, the higher the nonconformity score is, the less confident the VLM is in the correct answer or the less relevant the image is deemed to be. Calibration is then performed by defining \hat{q} to be the

$$\frac{⌈ ( N + 1 ) ( 1 - ϵ ) ⌉}{N}$$

empirical quantile of κ₁, . . . , κ_{N}. For a new input xₜₑₛₜ, CP generates C(xₜₑₛₜ)={y∈y|ρ(xₜₑₛₜ)_{y}≥1−\hat{q}}, i.e., the prediction set that includes all labels in which the predictor has at least 1-q relevance-weighted confidence. The generated prediction set ensures that the coverage guarantee in Equation (6) holds.

### B. Applying Multi-Step CP for Embodied Question Answering

Next, a description is provided to illustrate how CP provides a principled and more interpretable stopping criterion for multi-step exploration by building on the multi-step CP approach. Datapoints are considered corresponding to episode-level sequences of inputs. By performing calibration at the sequence level using a carefully chosen non-conformity score function, this ensures that prediction sets can be constructed causally (i.e., time-step by time-step) at test time.

Let x^{t} denote the input at time t consisting of the RGB image

$${I}_{c}^{t}$$

and the question q. Each episode results in a sequence x̅=(x⁰, x¹, . . . ) of such inputs. The distribution [symbol] over scenarios along with the exploration policy induces a distribution over input sequences x̅. The relevance-weighted confidence score is first defined at time t (analogous to the single-step definition of Equation (7)):

$${ρ}_{y}^{t} ( {x}^{t} ) := Rel ( {x}^{t} ) ( {\hat{f}}_{y} ( {x}^{t} ) - 1 ) . \qquad ( 8 )$$

This quantity is large when the input x^{t} at time t is deemed highly relevant and the VLM is confident in the answer y. The episode-level confidence is then defined as:

$${\overline{ρ}}_{y} ( x ) := {}_{t ∈ [ T ]}^{min} {ρ}_{y}^{t} ( {x}^{t} ) , \qquad ( 9 )$$

where T is the maximum allowable episode length. Given a calibration dataset

$$Z = {\{ {z}_{i} = ( {\overline{x}}_{i} , {y}_{i} ) \}}_{i = 1}^{N}$$

of input sequences (collected using the exploration policy) and ground-truth answers, the non-conformity score for data point i is defined as κᵢ: =1−ρ̅y_{i′}(x̅ᵢ).

However, at test-time, the robot does not obtain the entire sequence x̅ₜₑₛₜ at once; instead, the prediction sets must be causally constructed over time (i.e., using observations up to the current time). Define the causally constructed prediction set at time t to be:

$${C}^{t} ( {x}_{t e s t}^{t} ) := \{ y ∈ y \vert {ρ}_{y}^{t} ( {x}_{test}^{t} ) \geq 1 - \hat{q} \} . \qquad ( 10 )$$

Claim 1: For all time t∈[T], the causally constructed prediction set

$${C}^{t} ( {x}_{test}^{t} )$$

contains the sequence-level set C̅(x̅ₜₑₛₜ). Moreover,

$${⋂}_{t = 0}^{T} {C}^{t} ( {x}_{test}^{t} ) = \overline{C} ( {\overline{x}}_{test} ) .$$

Proposition 1: With probability 1−ϵ for test scenarios drawn from [symbol] , the ground-truth label yₜₑₛₜ is contained in the prediction set

$${⋂}_{k = 0}^{t} {C}^{k} ( {x}_{test}^{k} )$$

for all t∈[T].

Proof: This follows directly from the claim above and the fact that the sequence-level prediction set C̅(x̅ₜₑₛₜ) contains the ground-truth label with user-defined probability 1−ϵ as guaranteed by CP.

At test time, the set

$${C}^{t} ( {x}_{test}^{t} )$$

is constructed at each step and maintains the intersection of these sets over time. If the resulting intersection contains only a single element, the robot halts its exploration with 1-ϵ confidence that the corresponding answer is correct. Alternately, if the maximum allowable time horizon Tis reached and the intersected set contains multiple answers, or the intersected set is empty, the robot returns the answer y with highest \hat{f}_{y}(x^{t}) from time t with the highest Rel(x^{t}).

### IV. HM-EQA Dataset

While prior work has primarily considered synthetic scenes and simple questions such as “what is the color of the coffee table?” or “how many sofas are there in the living room?” involving basic attributes of relatively large pieces of furniture, various aspects of the present disclosure are interested in applying the proposed VLM-based framework in more realistic and diverse scenarios, where the question can be more open-ended and possibly require semantic reasoning. To this end, HM-EQA is proposed, a new EQA dataset based on the Habitat-Matterport 3D Research Dataset (HM3D), which provides hundreds of photo-realistic, diverse indoor 3D scans.

To generate questions that are realistic in typical household settings, GPT4-V, the state-of-the-art VLM, is leveraged to generate such questions based on twelve random views sampled inside an indoor scene from HM3D, and three sets of examples of manually written questions and answers given views of the corresponding scenes (one set per scene). Afterwards some of the questions are manually removed that are (1) too simple (e.g., “How many sofas are there in the living room for them to sit on?”) or (2) hallucinating objects that cannot be seen from the views by a human (e.g., eyeglasses, watering can, and remote control). Option (1) is considered too simple as it involves detection of very prominent objects in the scene (large). At the end, 500 questions are generated from 312 different scenes. The resulting questions can be divided into five categories (also showing their split within the whole dataset):
1) Identification (16.6%): asking about identifying the type of an object, e.g., “Which tablecloth is on the dining table? A) Red B) White C) Black D) Gray.”
2) Counting (18.4%): asking about the number of objects, e.g., “My friends and I were playing pool last night. Did we leave any cues on the table? A) None B) One C) Two D) Three.”
3) Existence (21.4%): asking if an object is present at a location, e.g., “Did I leave my jacket on the bench near the front door? A) Yes B) No.”
4) State (19.8%): asking about the state of an object, e.g., “Is the air conditioning in the living room turned on? A) Yes B) No” or “Is the curtain in the master bedroom closed? A) Yes B) No.”
5) Location (23.8%): asking about the location of an object, e.g., “Where have I left the black suitcase? A) At the corner of the bedroom B) In the hallway C) In the storage room D) Next to TV in the living room.”

Notice that some of the questions only involve two multiple choices, and the formulation in Section I assumes four. For consistency, if the question itself does not have four multiple choices, additional choices are added, e.g., “D) (Do not choose this option)” until there are four.

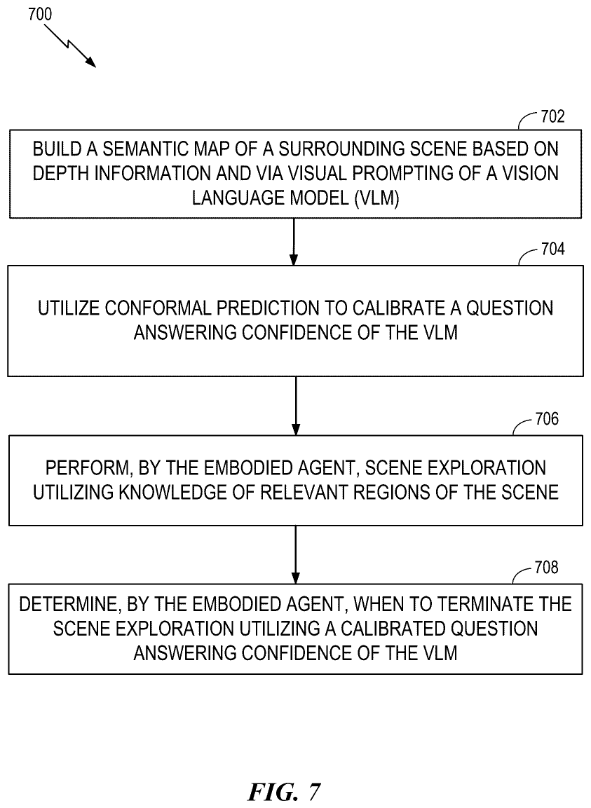

Since the different scenes e from HM3D can have vastly varied sizes (majority of which range from 100 m² to 800 m²), the maximum allowed time steps T_{ϵ} is set in each scene to be the square root of the 2D size times a factor of three. The initial pose of the robot g⁰ is sampled randomly from the free space in the scene. These examples have not fully defined the scenarios introduced in Section I, ϵ: =(e, T, g⁰, q, y) (q for question and y for answer). A process for embodied agent exploration is further illustrated in FIG. 7.

FIG. 7 is a flowchart illustrating a method 700 for embodied agent exploration, according to aspects of the present disclosure. The method 700 begins at block 702, in which a semantic map of a surrounding scene is built based on depth information and via visual prompting of a vision language model (VLM). For example, as shown in FIG. 4, a robot builds the semantic map 420 of the scene 402, in which the semantic map 420 stores information on occupancy and locations the VLM 410 deems worthy of exploring.

At block 704, conformal prediction is utilized to calibrate a question answering confidence of the VLM. For example, as shown in FIG. 3, the perception module 310 includes the VLM calibration module 314 to utilize conformal prediction to calibrate a question answering confidence of the VLM. As shown in FIG. 6, observations motivate rigorous quantification of the VLM's uncertainty and careful calibration of the raw confidences.

At block 706, the embodied agent performs scene exploration utilizing knowledge of relevant regions of the scene. For example, as shown in FIG. 3, the perception module 310 includes the scene exploration module 316 to perform, by the robot 350, scene exploration utilizing knowledge of relevant regions of the scene. As shown in FIG. 4, the semantic-value-weighted exploration 430 guides a fetch robot to explore relevant locations 440 (e.g., x, y, yaw of a next pose) for new observations. Using the semantic map 420 helps the robot explore more efficiently compared to conventional robotic exploration, which is performed without using any semantic information.

At block 708, the embodied agent determines when to terminate the scene exploration utilizing a calibrated question answering confidence of the VLM. Various aspects of the present disclosure employ multi-step conformal prediction, which allows the robot to maintain a set of answers (prediction set) over time and stop when the set reduces to a single answer. Conformal prediction (CP) uses a moderately sized (e.g., ˜300) set of scenarios for carefully selecting a confidence threshold above which answers are included in the prediction set. This procedure achieves calibrated confidence: with a user-specified probability, the prediction set is guaranteed to contain the correct answer for a new scenario (under the assumption that calibration and test scenarios are drawn from the same unknown distribution D). CP also minimizes the prediction set size, which helps the robot to stop as quickly as it can while satisfying calibrated confidence.

In some aspects of the present disclosure, the method 700 may be performed by the SOC 100 (FIG. 1) or the software architecture 200 (FIG. 2) of the robot 150 (FIG. 1). That is, each of the elements of method 700 may, for example, but without limitation, be performed by the SOC 100, the software architecture 200, or the processor (e.g., CPU 102) and/or other components included therein of the robot 150.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media may include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits, such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read-only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such with cache and/or specialized register files. Although the various components discussed may be described as having a specific location, such as a local component, they may also be configured in numerous ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more PGAs, PLDs, controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the application and the overall design constraints imposed on the overall system.

The machine-readable media may comprise several software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc; where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for embodied agent exploration, the method comprising:
building a semantic map of a surrounding scene based on depth information and via visual prompting of a vision language model (VLM);
utilizing conformal prediction to calibrate a question answering confidence of the VLM;
performing, by an embodied agent, scene exploration utilizing knowledge of relevant regions of the scene; and
determining, by the embodied agent, when to terminate the scene exploration utilizing a calibrated question answering confidence of the VLM.

2. The method of claim 1, in which building the semantic map comprises fusing common sense/semantic reasoning abilities of the VLM into a global geometric semantic map to enable efficient exploration.

3. The method of claim 1, in which the utilizing conformal prediction further comprises utilizing a multi-step conformal prediction to formally quantify a VLM uncertainty about a question.

4. The method of claim 1, in which building the semantic map comprises:
prompting the embodied agent using first potential points in a current view of the surrounding scene to obtain locally semantic values; and
prompting the embodied agent using second potential points in a global view of the surrounding scene to obtain globally semantic values.

5. The method of claim 4, further comprising:
generating a semantic value (SV) using a weighted combination of the locally semantic values; and
saving the semantic value SV in the semantic map.

6. The method of claim 5, in which determining further comprises utilizing the semantic value SV to guide the embodied agent toward unknown and relevant regions.

7. The method of claim 1, further comprising determining relevant locations to explore by obtaining the calibrated question answering confidence of the VLM over locations via visual prompting.

8. The method of claim 7, in which the determining of relevant locations further comprises identifying free space in a current RGB image by (a) projecting onto a 2D point map M, (b) keeping free points, and (c) sampling a set of points P using farthest point sampling to ensure coverage.

9. A non-transitory computer-readable medium having program code recorded thereon for embodied agent exploration, the program code being executed by a processor and comprising:
program code to build a semantic map of a surrounding scene based on depth information and via visual prompting of a vision language model (VLM);
program code to utilize conformal prediction to calibrate a question answering confidence of the VLM;
program code to perform, by the embodied agent, scene exploration utilizing knowledge of relevant regions of the scene; and
program code to determine, by the embodied agent, when to terminate the scene exploration utilizing a calibrated question answering confidence of the VLM.

10. The non-transitory computer-readable medium of claim 9, in which the program code to build the semantic map comprises program code to fuse common sense/semantic reasoning abilities of the VLM into a global geometric semantic map to enable efficient exploration.

11. The non-transitory computer-readable medium of claim 9, in which the program code to utilize the conformal prediction further comprises program code to utilize a multi-step conformal prediction to formally quantify a VLM uncertainty about a question.

12. The non-transitory computer-readable medium of claim 9, in which the program code to build the semantic map comprises:
program code to prompt the embodied agent using first potential points in a current view of the surrounding scene to obtain locally semantic values; and
program code to prompt the embodied agent using second potential points in a global view of the surrounding scene to obtain globally semantic values.

13. The non-transitory computer-readable medium of claim 12, further comprising:
program code to generate a semantic value (SV) using a weighted combination of the locally semantic values; and
program code to save the semantic value SV in the semantic map.

14. The non-transitory computer-readable medium of claim 13, in which the program code to determine further comprises program code to utilize the semantic value SV to guide the embodied agent toward unknown and relevant regions.

15. The non-transitory computer-readable medium of claim 9, further comprising program code to determine relevant locations to explore by obtaining the calibrated question answering confidence of the VLM over locations via visual prompting.

16. The non-transitory computer-readable medium of claim 15, in which the program code to determine of relevant locations further comprises program code to identify free space in a current RGB image by (a) projecting onto a 2D point map M, (b) keeping free points, and (c) sampling a set of points P using farthest point sampling to ensure coverage.

17. A system for embodied agent exploration, the system comprising:
a semantic map module to build a semantic map of a surrounding scene based on depth information and via visual prompting of a vision language model (VLM);
a calibration module to utilize conformal prediction to calibrate a question answering confidence of the VLM;
a scene exploration module to perform, by the embodied agent, scene exploration utilizing knowledge of relevant regions of the scene; and
an exploration termination module to determine, by the embodied agent, when to terminate the scene exploration utilizing a calibrated question answering confidence of the VLM.

18. The system of claim 17, in which the semantic map module is further to fuse common sense/semantic reasoning abilities of the VLM into a global geometric semantic map to enable efficient exploration.

19. The system of claim 17, in which the calibration module is further to utilize a multi-step conformal prediction to formally quantify a VLM uncertainty about a question.

20. The system of claim 17, in which the scene exploration module is further to determine relevant locations to explore by obtaining the calibrated question answering confidence of the VLM over locations via visual prompting.
